(19) United States
(12) Patent Application Publication
(10) Pub. No.: US 2023/0349773 A1
(43) Pub. Date: Nov. 2, 2023

(54) Measuring probe for temperatures of foods

(71) Applicant: BSH Hausgeräte GmbH, Munich (DE)

(72) Inventors: Harald Pfersch, Freilassing (DE); Uwe Has, Unterneukirchen (DE)

(21) Appl. No.: 18/134,620

(22) Filed: Apr. 14, 2023

(30) Foreign Application Priority Data
May 2, 2022 (DE) 102022204282.4

(51) Int. Cl. G01K 7/02; H05B 6/64

(52) U.S. Cl. CPC G01K 7/02; H05B 6/6452; G01K 2215/00; G01K 2207/02

(57) ABSTRACT

A measuring probe includes a measuring tip embodied for insertion into a food. Accommodated in the measuring tip is a thermocouple to determine a (core) temperature of the food, an energy storage unit to supply the measuring probe with electrical energy, and a light source to output a light signal as a function of the (core) temperature of the food determined by the thermocouple.

### CROSS-REFERENCES TO RELATED APPLICATIONS

This application claims the priority of German Patent Application, Serial No. 102022204282.4, filed May 2, 2022, pursuant to 35 U.S.C. 119(a)-(d), the disclosure of which is incorporated herein by reference in its entirety as if fully set forth herein.

### BACKGROUND OF THE INVENTION

The present disclosure relates to a measuring probe for measuring the (core) temperature of a food, a system comprising the measuring probe and a cooking appliance, and a method for preparing a food.

In order to prepare a food, in particular meat and fish products, in an ideal manner, it is advantageous to know a temperature and/or a change in temperature over time inside the food. This temperature is also referred to as the core temperature, and allows conclusions to be drawn as to the progress currently achieved in preparing a food at a given point in time. In order to determine the core temperature of the food, (temperature) measuring probes are used in the prior art which are inserted into the food and are “cooked” along with the food.

Various measuring probes are known. In general, the measuring probe contains at least one temperature sensor close to the tip of the measuring probe which ascertains a temperature at the tip of the measuring probe. The temperature determined by the temperature sensor is typically forwarded via wires and connectors to evaluation electronics. In a cooking appliance which is embodied with the measuring probe, the evaluation electronics are usually located outside an oven cavity of the cooking appliance in which a food preparation process is being carried out.

However, the wires and connectors connecting the measuring probe to the evaluation electronics impose handling limitations on a user. For example, the measuring probe must be removed from the food in a hot state while still inside the oven cavity or on a slide directly in front of the oven cavity because the wires are not sufficiently long to allow the food to be lifted complete with the measuring probe onto a worktop or the like.

To solve this problem, measuring probes are known in the prior art which transmit the determined temperature wirelessly.

One example of a measuring probe which transmits the determined temperature wirelessly is disclosed in EP 3 314 225 A1. The measuring probe disclosed here in the form of a food thermometer contains a first section containing the electrical components, which are temperature-sensitive. The first section is provided and embodied to be positioned in the food. By the electrical components being provided in the first section, it is possible to ensure that the electrical components are exposed at most to a temperature of the food and not to a significantly higher cooking compartment temperature. An intermediate piece adjoins the first section. A temperature sensor is embodied in at least the first section or in the intermediate piece. The temperature sensor is provided and embodied to detect the (core) temperature of the food. The measuring probe further contains an antenna at an end spaced apart from the first section, in order to transmit the determined (core) temperature to an external receiver by means of radio waves.

The prior art is disadvantageous in that at least the antenna is positioned outside the food during a cooking process and is thus exposed to the higher cooking compartment temperatures. This can lead to a premature aging of the antenna and thus to a premature failure of the measuring probe.

The prior art is further disadvantageous in that such a measuring probe cannot be used in microwave cooking appliances, as the microwaves generated by a microwave generator sometimes prevent or at least significantly impede a transmission of the determined (core) temperature by means of radio waves.

The prior art is further disadvantageous in that the external receiver tuned to the radio waves is necessary in order to transmit the determined (core) temperature.

An object of the present invention is to provide a measuring probe in which all relevant components, in a state in which the measuring probe is determining the (core) temperature of a food, i.e. positioned in the food, are protected against the cooking compartment temperature and in particular an antenna is not exposed to the cooking compartment temperature.

It is also an object of the present invention to provide a measuring probe which can also be used in a microwave cooking appliance.

A further object of the present invention is to provide a system which can be operated without an external receiver tuned to the radio waves.

### SUMMARY OF THE INVENTION

According to one aspect of the invention, a measuring probe, includes a measuring tip embodied for insertion into a food, a thermocouple accommodated in the measuring tip and designed to determine a (core) temperature of the food, an energy storage unit accommodated in the measuring tip and designed to supply the measuring probe with electrical energy, and a light source accommodated in the measuring tip and designed to output a light signal as a function of the (core) temperature of the food determined by the thermocouple.

The measuring probe may be a measuring apparatus or a cooking thermometer.

The measuring tip thus represents an end section of the measuring probe. Advantageously, the measuring tip and hence the end section of the measuring probe has a pointed configuration. The measuring tip is inserted fully into the food during the cooking process. The thermocouple in the measuring tip is embodied to detect the (core) temperature of the food at a point where the measuring tip is located.

According to another advantageous feature of the invention, a control apparatus accommodated in the measuring tip can receive a temperature signal determined by the thermocouple and convert the temperature signal into a transmission signal which is output by the light source in the form of the light signal. The light signal can be an optically detectable signal with a defined wavelength, a defined frequency, a defined intensity and/or the like. A defined frequency is to be understood to mean that the light source is switched on and off in a defined sequence. The light signal is directly dependent on the determined (core) temperature or is controlled on the basis of the determined (core) temperature. The thermocouple, the optional control apparatus and the light source are supplied with electrical energy by the energy storage unit.

Accordingly, a feature of the invention is that the measuring probe optically encodes the determined (core) temperature of the food and outputs it as a light signal via the light source.

Such an optical transmission/emission of the (core) temperature is not influenced by microwaves which are generated by a microwave generator in a microwave cooking appliance. In this way, it is possible in a problem-free manner to use the measuring probe in a microwave cooking appliance. Furthermore, a measuring probe according to the invention makes it possible to dispense with the need for a conventional antenna, so that a risk of premature measuring probe failure on account of an increased cooking compartment temperature can be reduced significantly. The measuring tip and thus the entire electronics of the measuring probe are located in the food during the cooking process. Temperatures of at most 100° C. are reached in the food during the cooking process. Furthermore, because the (core) temperature of the food determined by the thermocouple is transmitted via the light signal, an external receiver tuned to radio waves can be dispensed with and the light signal can be detected by a camera already embodied in a cooking appliance and/or by a user with the naked eye.

The light source can advantageously be an LED. LEDs emit a narrowband light in comparison to conventional light sources. The narrowband light is easier for a sensor system to identify and allocate.

According to another advantageous feature of the invention, provision may be made for a light guide, which receives the light signal and guides the light signal from the light source in the measuring tip along a longitudinal direction of the measuring probe to an end of the measuring probe, which end faces away from the measuring tip. The light guide may be rectangular or square and may be made of transparent material. Advantageously, the light guide may be made of a temperature-stable material, for example glass or a temperature-stable, transparent plastic. In this context, a light guiding of the light guide can be achieved for example by total reflection on account of a low refractive index of a medium surrounding the light guide and/or by mirroring of a boundary surface of the light guide and/or by a suitable refractive gradient.

According to another advantageous feature of the invention, the light guide can be designed to receive the light signal via a coupling-in surface, which can be arranged adjacent to the light source and configured to receive the light signal emitted by the light source.

The light signal can be guided through the light guide to the end of the measuring probe facing away from the measuring tip. Because the measuring tip is located in the food during preparation of the food, the light signal can be transported reliably out of the food in this manner without the light signal being corrupted or its intensity being significantly reduced.

According to another advantageous feature of the invention, the end facing away from the measuring tip can include a coupling-out surface, which outputs the light signal to a surrounding area of the measuring probe. Thus, the light signal output by the light source in the measuring tip can be input into the light guide at the coupling-in surface of the light guide, subsequently guided through the light guide to the end facing away from the measuring tip, and irradiated here by way of the coupling-out surface. In this way, the light signal can be output at a defined distance from the food or at a defined position of the measuring probe, and can be identified easily and unambiguously by a user or by a sensor system even if the measuring probe has not been perfectly aligned toward a window of a cooking appliance or the sensor system.

According to another advantageous feature of the invention, the coupling-out surface can be embodied as a scatter surface/diffusor and output the light signal in a multi- or omnidirectional manner to the end facing away from the measuring tip. The coupling-out surface can output the light signal by means of a diffuse reflection and/or refraction in an enlarged solid angle region about the end facing away from the measuring tip as a scatter surface.

By configuring the coupling-out surface as a scatter surface, the coupling-out surface can be enlarged, i.e. the surface by way of which the light signal is output can be enlarged. A detectability of the light signal by the user or by the sensor system can thus be improved significantly, as the light signal is output in a “lighthouse-like manner”. The end of the measuring probe facing away from the measuring tip appears to output or shine the light signal “as a whole”. The light signal is thus readily visible/detectable from all directions. In this way, it is possible to ensure that the light signal remains readily detectable despite any splashes or other impurities unavoidably deposited on the coupling-out surface during the preparation of the food.

According to another advantageous feature of the invention, provision may be made for a plurality of light sources to output the light signal, wherein the plurality of light sources or the light signals output thereby can differ in terms of their wavelength. Several light sources can be embodied in the measuring tip which output the light signal or several light signals which differ from one another. The several light sources can be embodied in the measuring tip in the form of LEDs which output different-colored light. Mixed colors based on an additive color mixing can be formed in the light guide on account of the several light sources.

In particular, at least or exactly three light sources can be embodied in the measuring tip, wherein these can be one red, one green and one blue light source and thus an RGB color space can be fully mapped. Alternatively or in addition, at least one of the light sources can output light outside a color spectrum/light spectrum perceivable by a human. In particular, this can be infrared light or ultraviolet light.

The light guide can have one coupling-in surface for each of the light sources. Alternatively, the light guide can have one coupling-in surface for several light sources together. The at least one coupling-in surface can also be embodied as a scatter surface/diffusor. This additionally improves an even illumination of the coupling-out surface.

The at least one light source and the associated coupling-in surface can be positioned relative to one another such that the outgoing light signal from the light source strikes the associated coupling-in surface as perpendicularly as possible.

According to another advantageous feature of the invention, the light guide can have a round cross-sectional surface, advantageously a circular cross-sectional surface.

According to another advantageous feature of the invention, the light guide can have a constriction/clearance relative to the cross-sectional surface. The light guide can thus change its cross-section along its longitudinal extension. On account of such a constriction, space can be made available for other components, such as for example a (further) temperature sensor.

According to another advantageous feature of the invention, provision may be made for a light-sensitive element designed to receive optical control signals for controlling the measuring probe. Advantageously, the light-sensitive element can be a photodiode. A photodiode is a semiconductor diode which uses an internal photo effect to convert light into an electrical current or provides this with a lighting-dependent resistance. Advantageously, the light-sensitive element can be embodied in the measuring tip, adjacent to the light source.

The light-sensitive element can therefore, based on light signals from a surrounding area of the measuring probe, output the lighting-dependent electrical current or the lighting-dependent resistance, on the basis of which for example the control apparatus of the measuring probe can be controlled. When accommodating the light-sensitive element in the measuring tip, the light signal can be guided from the surrounding area through the light guide to the light-sensitive element. As a result, the light signal enters the light guide via what is actually the coupling-out surface and exits the light guide via what is actually the coupling-in surface.

According to another advantageous feature of the invention, the measuring probe can control an emission frequency of the light signal as a function of the determined (core) temperature, i.e. the measuring probe only emits the light signal if an emission is relevant for the cooking process to be monitored. The emission frequency can be very low at the start of the cooking process (for example just one light signal every three minutes). If however the determined (core) temperature is increased, for example exceeds a predefined limit value, the emission frequency can however be increased (for example one light signal every 30 seconds). In this way, it is possible to reduce an energy consumption of the measuring probe and thus extend a possible duration of use of the measuring probe. The predefined limit value can be predefined for example at 35° C. The predefined limit value can be changed for example via the light-sensitive element in the measuring probe.

The light signal can also contain information about a charging state of the energy storage unit of the measuring probe in addition to the (core) temperature. In this way, it is possible to identify when the energy storage unit of the measuring probe is running down and a failure of the measurement electronics is to be expected.

According to another aspect of the invention, a system includes a measuring probe designed for insertion into a food and including a light source designed to output a light signal as a function of a (core) temperature of the food, and a cooking appliance including an optical detector designed to detect the light signal and an evaluation unit designed to convert the light signal detected by the optical detector into display and/or control signals for the cooking appliance.

According to another advantageous feature of the invention, the optical detector can be a camera.

A system according to the invention contains the measuring probe with the light source, which outputs the light signal, which displays/contains as information the (core) temperature of the food, and the cooking appliance, which detects the light signal with the optical detector. The light source of the measuring probe and the optical detector of the cooking appliance can be tuned to one another. The core temperature determined by the measuring probe can be transmitted to the cooking appliance via the light signal. The cooking appliance evaluates the light signals and converts them into display and/or control signals. The display signal can be for example a signal that causes a screen of the cooking appliance to display the current (core) temperature of the food. The control signal can be for example a signal that causes a control unit of the cooking appliance to change a cooking program or a cooking compartment temperature.

In a system according to the invention, the measuring probe can be embodied without an antenna, so that a risk of premature measuring probe failure on account of an increased cooking compartment temperature can be reduced significantly. Furthermore, because the (core) temperature of the food determined by the thermocouple is transmitted via the light signal, an external receiver tuned to radio waves in the cooking appliance can be dispensed with and the light signal can be detected by a camera already embodied in the cooking appliance and/or by a user with the naked eye. A sensor system already contained in the cooking appliance can be used as the receiver. This reduces manufacturing costs of the cooking appliance.

Alternatively or additionally, the optical detector can be an infrared detector. In this case, the light source can emit light signals with a wavelength of 900 nm and more. Such signals in the infrared range are imperceptible to the naked eye. In this manner, an irritation of the user can be prevented. In addition, a signal transmission by means of infrared offers the advantage that it is not impaired by an ambient light being incident through a window of the cooking appliance door.

According to another advantageous feature of the invention, the cooking appliance can include a microwave generator, and the measuring probe can be designed in a manner as set forth above and can further include an energy converter designed to convert microwaves generated by the microwave generator into electrical energy and to feed the electrical energy into the energy storage unit of the measuring probe.

The cooking appliance can be a microwave cooking appliance or an oven with microwave functionality. The energy converter can be embodied in the measuring probe, advantageously in a position protruding from the food. The energy converter can convert the electrical field generated by the microwave generator in the cooking appliance at least partially into electrical energy and feed this into the energy storage unit in the measuring tip of the measuring probe. In this way, a usage period of the measuring probe can be extended significantly, as this can be charged during operation. In addition, the energy storage unit in the measuring probe can be embodied more compactly.

According to another advantageous feature of the invention, the cooking appliance of the system can include a lighting unit, in particular a cooking compartment lighting unit. The cooking compartment lighting unit can be embodied to emit control signals in the form of lighting unit signals, which can be detected by the light-sensitive element of the measuring probe. The measuring probe can be controlled on the basis of the control signals or lighting unit signals. For example, the predefined limit value from which the emission frequency of the light signal is to be increased can thus be entered on the cooking appliance by a user and then transmitted to the measuring probe with the aid of the lighting unit signals.

According to another advantageous feature of the invention, the cooking appliance of the system can be embodied with a measuring probe receptacle, which receives the measuring probe when not in use and charges the energy storage unit of the measuring probe. The measuring probe receptacle can furthermore be embodied with a measuring probe detection unit, which detects whether the measuring probe is inserted into the measuring probe receptacle. The cooking appliance can optionally output a warning on a screen and/or acoustically if the measuring probe is not positioned in the measuring probe receptacle, in particular at a point in time at which the measuring probe should be positioned in the measuring probe receptacle.

According to another advantageous feature of the invention, the cooking appliance of the system can output an optical and/or acoustic alarm if the cooking appliance does not receive a light signal from the measuring probe but a cooking program is set which requires the measuring probe and/or the measuring probe is not located in the measuring probe receptacle.

According to another advantageous feature of the invention, the optical detector of the cooking appliance can be embodied with an optical conductor, which is placed onto the measuring probe in the form of a hose-shaped element. The optical conductor can be embodied as a high-temperature-resistant light guide.

According to yet another aspect of the invention, a method for preparing a food includes detecting a (core) temperature of the food via a measuring probe, outputting with the measuring probe a light signal based on the (core) temperature of the food, detecting the light signal by a cooking appliance, and outputting the (core) temperature of the food by the cooking appliance and/or adjusting a preparation parameter by the cooking appliance as a function of the detected light signal.

The measuring probe thus detects the (core) temperature of food in a first step, advantageously using the thermocouple. In a second step, the determined (core) temperature is encoded in the light signal, in particular by a control apparatus embodied in the measuring tip, and the light signal is output by the measuring probe. In a third step, the cooking appliance detects the light signal, advantageously with a camera, and decodes the (core) temperature encoded in the light signal, advantageously with an evaluation unit. In a fourth step, the cooking appliance outputs the determined (core) temperature of the food, advantageously on a screen. Alternatively or additionally, the cooking appliance adjusts preparation parameters, such as for example the cooking compartment temperature and/or the cooking program, based on the core temperature.

### BRIEF DESCRIPTION OF THE FIGURES

FIG. 1 is a view of a measuring probe according to the invention;

FIG. 2 is an enlarged sectional view of a measuring tip of the measuring probe;

FIG. 3 is a schematic view of a light guide in a first embodiment;

FIG. 4 is a first transparent view of the light guide in the first embodiment;

FIG. 5 is a second transparent view of the light guide in the first embodiment with a beam progression with a first light source;

FIG. 6 is a third transparent view of the light guide in the first embodiment with the beam progression with the first light source and a second light source;

FIG. 7 is a schematic view of the light guide in a second embodiment with four light sources;

FIG. 8 is a schematic view of the light guide in a second embodiment with three light sources and a light-sensitive element;

FIG. 9 is a schematic view of a light guide tip in a third embodiment with a multiplicity of light sources and a light-sensitive element;

FIG. 10 is a schematic view of a light guide in a fourth embodiment;

FIG. 11 is a schematic view of a light guide in a fifth embodiment;

FIG. 12 is a schematic view of a system according to the invention; and

FIG. 13 is a flowchart of a method for preparing food.

### DESCRIPTION OF THE EXEMPLARY EMBODIMENTS

Exemplary embodiments of the present disclosure are described below on the basis of the associated figures.

### First Exemplary Embodiment

FIG. 1 shows a measuring probe 2 with a measuring tip 4, a shaft 6 and a light-emitting tip 8. The measuring probe 2 has an essentially pencil-shaped outer geometry. The shaft 6 has a round (circular) cross-sectional surface at right angles to a longitudinal extension of the measuring probe 2. Starting from the shaft 6, the measuring tip 4 tapers in the shape of a (pointed) cone. The light-emitting tip 8 is embodied at an end of the measuring probe 2 or of the shaft 6 facing away from the measuring tip 4. The light-emitting tip 8 is embodied in particular in a domed shape. The shaft 6 and the measuring tip 4 are advantageously embodied from metal or a high-temperature-resistant plastic. The shaft 6 and the measuring tip 4 can advantageously be embodied in one (material) piece.

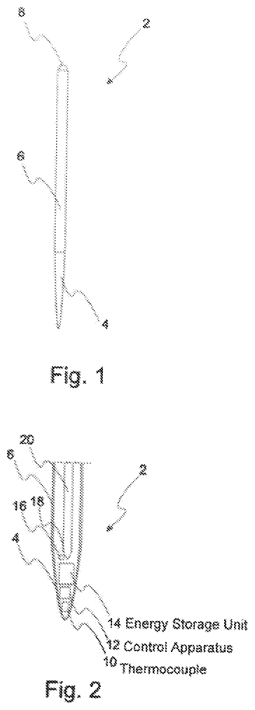

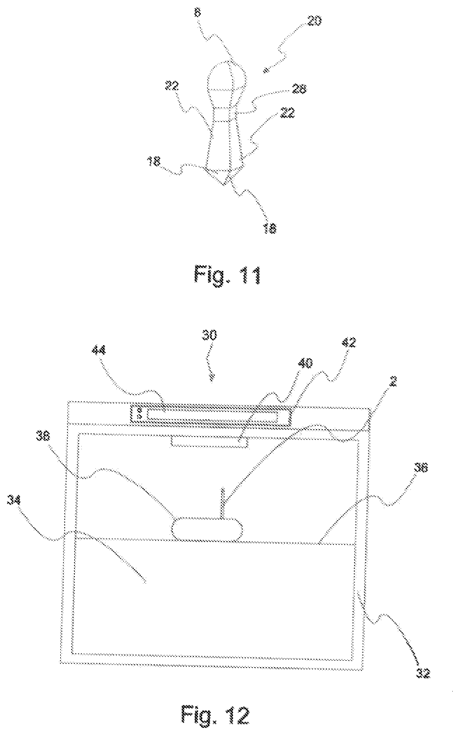

FIG. 2 shows the measuring tip 4 in a section parallel to the longitudinal extension of the measuring probe 2. The measuring tip 4 contains a thermocouple 10, which is provided and embodied to determine a temperature of a medium/substance/object located around the outside of the measuring tip 4. When the measuring probe 2 is used in accordance with its intended purpose, the medium is specifically a food (cf. 38 in FIG. 12). Furthermore, a control apparatus 12 and an energy storage unit 14 are embodied in the measuring tip 4. The temperature determined by the thermocouple 10 is entered as an input variable into the control apparatus 12. The control apparatus 12 converts the temperature into an output signal. The measuring tip 4 also contains a light source, which is an LED 16 in the exemplary embodiment shown here. The output signal generated by the control apparatus 12 is output by the LED 16 as a light signal. Here, the LED 16 is arranged such that it inputs the light signal into a light guide 20 substantially vertically via a coupling-in surface 18. The light guide 20 extends along a center fiber of the measuring probe between the measuring tip 4 and the light-emitting tip 8. The light-emitting tip 8 is embodied in one material piece with the light guide 20. In other words, the light-emitting tip 8 is an integral part of the light guide 20.

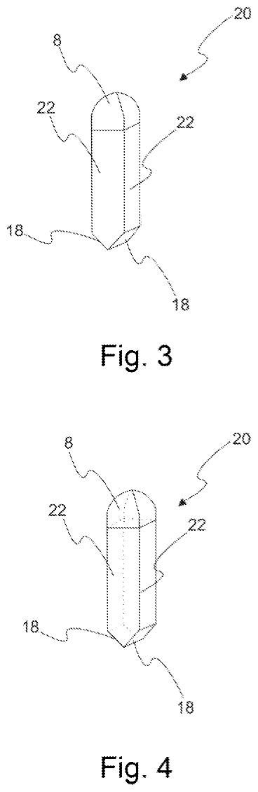

FIG. 3 and FIG. 4 show the light guide 20 in a first embodiment, wherein the light guide 20 has a substantially rectangular, in particular square, cross-sectional surface. FIG. 3 shows the light guide 20 here in a perspective view. FIG. 4 shows the light guide 20 in a partially transparent view. In the first embodiment, the light guide contains two coupling-in surfaces 18 arranged in a gable-roof-shaped manner. The coupling-in surfaces 18 are embodied in an end of the light guide facing toward the measuring tip 4 in an installed state. An end of the light guide facing away from the coupling-in surfaces 18 is embodied as the dome-shaped light-emitting tip 8. Expressed differently, lateral surfaces 22 of the light guide 20 converge in a punctiform manner at the light-emitting tip 8.

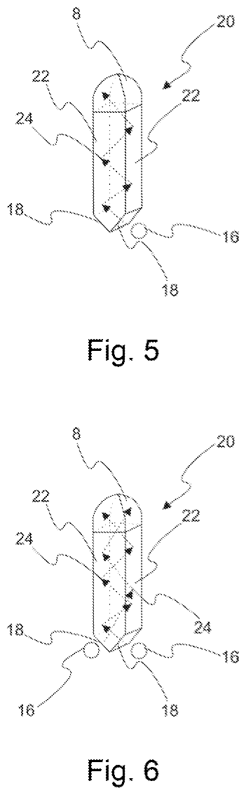

FIG. 5 shows the light guide 20 in the partially transparent view from FIG. 4, wherein the light signal 24 is input from the LED 16 into the light guide 20 via the coupling-in surface 18. The light signal 24 is reflected by means of a total reflection on the inside of the lateral surfaces 22 of the light guide 20 and guided along the longitudinal direction of the light guide. The light-emitting tip 8 is a coupling-out surface of the light guide 20, via which the light signal 24 is output to a surrounding area. To ensure that the light signal 24 is output as evenly as possible at the light-emitting tip 8, the light-emitting tip 8 is roughened. Expressed differently, the light-emitting tip 8 has a roughened surface. The coupling-in surface 18 can also optionally have a roughened surface.

FIG. 6 shows the light guide 20 in the partially transparent view from FIG. 4. This differs from FIG. 5 in that two LEDs 16 are arranged on the light guide 20. Expressed more precisely, one LED 16 is arranged on each of the two coupling-in surfaces 18 of the light guide 20 which are arranged in a gable-roof-shaped manner. The two LEDs 16 differ in terms of their wavelength. Expressed differently, the two LEDs 16 differ in terms of their light color. As a result of an additive color mixing in the light guide 20, more than two (light) colors can be output at the light-emitting tip 8.

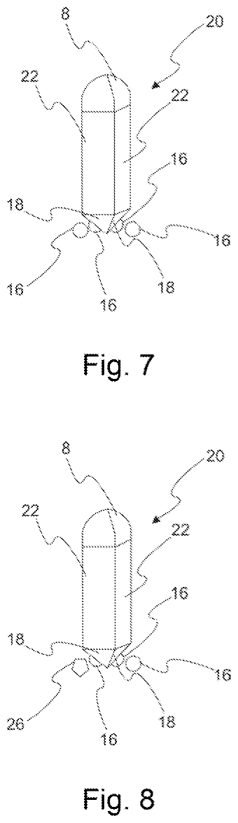

FIG. 7 shows the light guide 20 in a second embodiment. The light guide 20 differs from the first embodiment in that it has four coupling-in surfaces 18. Here, the coupling-in surfaces 18 are arranged in a pyramid shape and converge at a point on a center fiber of the light guide. In the exemplary embodiment shown in FIG. 7, an LED 16 is assigned to each of the coupling-in surfaces 18. The four LEDs 16 differ in terms of their wavelength and their light color. One of the four LEDs 16 is red in color, one of the four LEDs 16 is green in color, and one of the four LEDs 16 is blue in color. With these three colors, as a result of the additive color mixing in the light guide 20 each color of an RGB color space can be output at the light-emitting tip 8. The fourth LED 16 emits infrared light or alternatively UV light.

Alternatively, three LEDs 16 and three coupling-in surfaces 18 arranged in a pyramid shape can be embodied on the light guide.

FIG. 8 shows the light guide 20 from FIG. 7. The fourth LED 16 in FIG. 7 is however replaced by a light-sensitive element in the form of a photodiode 26. The photodiode 26, based on control light signals from a surrounding area of the measuring probe 2, outputs a lighting-dependent electrical current or a lighting-dependent resistance, on the basis of which the control apparatus 12 of the measuring probe 2 can be controlled. The control light signal from the surrounding area is guided through the light guide 20 to the photodiode 26. Here, the control light signal enters the light guide 20 via the light-emitting tip 8 and exits the light guide 20 via the coupling-in surface 18.

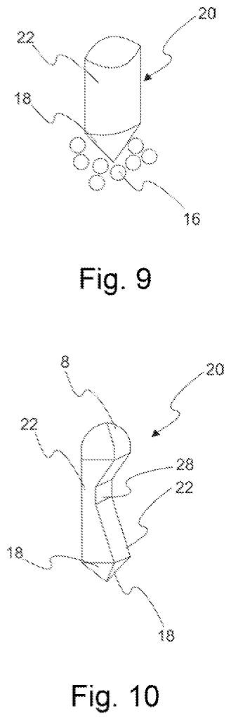

FIG. 9 shows a tip of the light guide 20 in a third embodiment. The light guide 20 has a circular cross-sectional surface. In other words, the light guide 20 has an essentially cylindrical geometry. The light guide in the third embodiment has precisely one coupling-in surface 18, which is embodied in the shape of a (pointed) cone on an end section of the light guide. LEDs 16 in the shape of a (circular) ring are advantageously embodied about the coupling-in surface 18. Alternatively, in the third embodiment too, one of the LEDs can be replaced by a photodiode 26.

FIG. 10 shows the light guide 20 in a fourth embodiment, wherein the light guide 20 in the fourth embodiment, in particular with regard to the coupling-in surfaces 18 and the light-emitting tip 8, corresponds to the light guide 20 of the second embodiment. The light guide 20 in the fourth embodiment contains a constriction 28. In other words, the light guide 20, or the cross-sectional surface of the light guide 20, tapers in the fourth embodiment. This constriction 28 is embodied on one side in the fourth embodiment; this means that the constriction 28 is embodied by a substantially wedge-shaped clearance in the light guide 20. The clearance provides a space between the light guide 20 and the shaft 6 of the measuring probe 2. Further electronic components, for example a (further) cooking compartment thermocouple which monitors a temperature of the cooking compartment, can be embodied in the clearance.

FIG. 11 shows the light guide 20 in a fifth embodiment, wherein the light guide 20 in the fifth embodiment, in particular with regard to the coupling-in surfaces 18 and the light-emitting tip 8, corresponds to the light guide 20 of the second embodiment Like the light guide 20 of the fourth embodiment, the light guide 20 of the fifth embodiment contains the constriction 28. In contrast to the fourth embodiment, the constriction 28 is embodied symmetrically in the light guide 20. In other words, each cross-sectional surface of the light guide 20 is symmetrical to the center fiber of the light guide 20 which runs at right angles to the cross-sectional surface.

FIG. 12 shows a system according to the invention comprising the measuring probe 2 and a cooking appliance 30. The cooking appliance 30 contains an oven muffle 32, which surrounds a cooking compartment 34. A carrier for food to be cooked is embodied in the cooking compartment 34 in the form of a baking sheet 36. A food 38 being prepared in the cooking appliance 30 is positioned on the baking sheet 36. The measuring probe 2 is inserted in the food 38. In particular, the measuring tip 4 is inserted fully in the food 38. The light-emitting tip 8 protrudes from the food 38 in a lighthouse-like manner. An optical detector is embodied on a top side of the oven muffle 32 in the form of a camera 40 pointing into the cooking compartment 34 of the cooking appliance 30. The measuring probe 2 emits the light signal 24 via the light-emitting tip 8, which light signal is detected/ascertained by the camera 40. An evaluation unit 42 of the cooking appliance 30 converts the light signal 24 detected by the camera 40 into display and/or control signals for the cooking appliance 30. The display signals are transmitted to a display apparatus 44 of the cooking appliance 30 and output via the display apparatus 44. The display signals can relate for example to a current core temperature of the food 38 or an (estimated) residual preparation time of the food. The control signals can change preparation parameters of the cooking appliance 30. The preparation parameters can relate for example to a cooking compartment temperature or a cooking program.

In an alternative embodiment not shown, the optical detector can be embodied on a side wall or on a rear wall or on a door of the cooking compartment.

In a further alternative embodiment not shown, more than one optical detector can be embodied in the cooking compartment.

In a further alternative embodiment not shown, the cooking appliance can contain a microwave generator which emits microwaves into the cooking compartment.

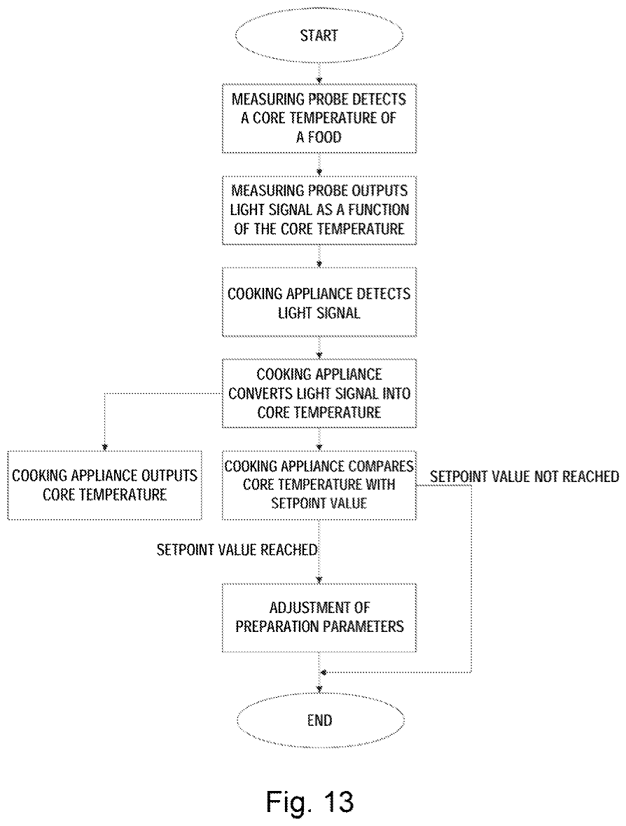

FIG. 13 describes an exemplary food preparation process in a system according to the invention. In a first step, the measuring probe detects the core temperature of the food. In a second step, the measuring probe encodes the core temperature into a light signal, which the measuring probe outputs. The cooking appliance uses a suitable sensor system to detect the light signal in a third step and decodes the core temperature of the food encoded in the light signal in a fourth step. The decoded core temperature of the food is output by the cooking appliance in a fifth step. In addition, the cooking appliance compares the core temperature with a stored setpoint value. The setpoint value can be stored in a database in the cooking appliance and/or in a network to which the cooking appliance is connected. Alternatively or additionally, the setpoint value can be entered or adjusted by a user. If the cooking appliance establishes that the setpoint value has not yet been reached, the process starts from the beginning. If the cooking appliance establishes that the setpoint value has been reached, the cooking appliance adjusts preparation parameters in a final step.

The cooking appliance can optionally subtract a delta from the setpoint value in order to prevent control overswings of the core temperature of the food during preparation.

The cooking appliance can also optionally adjust the preparation parameters even if the setpoint value has not yet been reached. For example, the cooking appliance can adjust the preparation parameters if a detected actual preparation progression does not match a stored setpoint preparation progression.

Alternatively or additionally, the cooking appliance can output a ready alarm signal when the setpoint value is reached.

Alternatively or additionally, the cooking appliance can output a ready soon alarm signal shortly before the setpoint value is reached.

Both the ready alarm signal and ready soon alarm signal can be an acoustic and/or an optical alarm signal.

Alternatively or additionally, the measuring probe can output the ready alarm signal and/or the ready soon alarm signal via the light-emitting tip.

Alternatively, the preparation process can take place without the comparison of the core temperature with the setpoint value, instead outputting only the determined core temperature.

The preparation parameters can relate for example to a cooking compartment temperature.

A repetition frequency of the process can depend on the determined core temperature and/or on a temperature delta between the determined core temperature and the setpoint value. Accordingly, the process can be carried out less frequently at lower core temperatures or with a larger temperature delta than at higher core temperatures or with a smaller temperature delta.

What is claimed is:

1. A measuring probe, comprising:
a measuring tip embodied for insertion into a food;
a thermocouple accommodated in the measuring tip and designed to determine a (core) temperature of the food;
an energy storage unit accommodated in the measuring tip and designed to supply the measuring probe with electrical energy; and
a light source accommodated in the measuring tip and designed to output a light signal as a function of the (core) temperature of the food determined by the thermocouple.

2. The measuring probe of claim 1, further comprising a light guide receiving the light signal and guiding the light signal from the light source in the measuring tip along a longitudinal direction of the measuring probe to an end of the measuring probe, which end faces away from the measuring tip.

3. The measuring probe of claim 2, wherein the light guide is rectangular.

4. The measuring probe of claim 2, wherein the light guide is square.

5. The measuring probe of claim 2, wherein the light guide is designed to receive the light signal via a coupling-in surface.

6. The measuring probe of claim 2, wherein the light guide has a cross-sectional surface which changes over the longitudinal direction of the measuring probe.

7. The measuring probe of claim 2, wherein the end facing away from the measuring tip includes a coupling-out surface via which the light signal is output to a surrounding area of the measuring probe.

8. The measuring probe of claim 7, wherein the coupling-out surface is embodied as a scatter surface and outputs the light signal in an omnidirectional manner at the end facing away from the measuring tip.

9. The measuring probe of claim 1, wherein the light source is designed to output a plurality of said light signal with different wavelengths.

10. The measuring probe of claim 1, further comprising a plurality of said light source designed to output light signals of different wavelength.

11. The measuring probe of claim 1, further comprising a light-sensitive element designed to receive optical control signals for controlling the measuring probe.

12. The measuring probe of claim 11, wherein the light-sensitive element is a photodiode.

13. The measuring probe of claim 1, further comprising a control apparatus accommodated in the measuring tip and receiving from the thermocouple an input variable commensurate with the (core) temperature of the food for conversion of the temperature into an output signal.

14. A system, comprising:
a measuring probe designed for insertion into a food and including a light source designed to output a light signal as a function of a (core) temperature of the food; and
a cooking appliance including an optical detector designed to detect the light signal, and an evaluation unit designed to convert the light signal detected by the optical detector into display and/or control signals for the cooking appliance.

15. The system of claim 14, wherein the optical detector is a camera.

16. The system of claim 14, wherein the cooking appliance includes a microwave generator, said measuring probe including a measuring tip embodied for insertion into the food and including a thermocouple accommodated in the measuring tip and designed to determine a (core) temperature of the food, an energy storage unit accommodated in the measuring tip and designed to supply the measuring probe with electrical energy, and an energy converter designed to convert microwaves generated by the microwave generator into electrical energy and to feed the electrical energy into the energy storage unit of the measuring probe, said light source of the measuring probe being accommodated in the measuring tip and outputting the light signal as a function of the (core) temperature of the food determined by the thermocouple.

17. A method for preparing a food, the method comprising:
detecting a (core) temperature of the food via a measuring probe;
outputting with the measuring probe a light signal based on the (core) temperature of the food;
detecting the light signal by a cooking appliance; and
outputting the (core) temperature of the food by the cooking appliance and/or adjusting a preparation parameter by the cooking appliance as a function of the detected light signal.
